(19) United States
(12) Patent Application Publication
(10) Pub. No.: US 2010/0268801 A1
(43) Pub. Date: Oct. 21, 2010

(54) WIRELESS APPARATUS AND NETWORK CONFIGURING METHOD

(75) Inventor: Koji Yukimasa, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/725,774

(22) Filed: Mar. 17, 2010

(30) Foreign Application Priority Data
Apr. 17, 2009 (JP) 2009-101380

(51) Int. Cl. G06F 15/177

(52) U.S. Cl. 709/220

(57) ABSTRACT

Provided is a technique whereby a device can be shared efficiently by multiple hosts in a network having a host as a control apparatus and a device has a controlled apparatus. A communication system that includes a wireless apparatus having a host function in which the wireless apparatus serves as a control apparatus and a device function in which the wireless apparatus serves as a controlled apparatus constructs a first network in which a first wireless apparatus serves as a host and a second wireless apparatus serves as a device, and constructs a second network in which the first wireless apparatus serves as a device and the second wireless apparatus serves as a host based upon a connection request transmitted from the second wireless apparatus to the first wireless apparatus via the first network.

### BACKGROUND OF THE INVENTION

1. Field of the Invention

The present invention relates to a wireless apparatus having a host function in which the wireless apparatus serves as a control apparatus and a device function in which the wireless apparatus serves as a controlled apparatus, and to a network configuring method.

2. Description of the Related Art

Short-distance high-speed wireless communication that relies upon a wireless USB (referred to as “WUSB” below) using ultra-wideband (UWB) has been developed in recent years. WUSB conforms to the WiMedia protocol. In WUSB, there is a host serving as a control apparatus and a device serving as a controlled apparatus. WUSB further includes a dual-role device (referred to as a “DRD” below) having both a host function and a device function, and a concurrent device controlled by multiple hosts.

Since WUSB is a technology obtained by expanding USB into the wireless realm, multiple devices can be connected to a host just as in the case of wired USB. Although a wireless communication apparatus that is a concurrent device is capable of communicating with multiple hosts simultaneously, there is only one host to which another device can be connected. Even in the case of a wireless communication apparatus that is a DRD, there is only one connectable host on the device-function side.

In order for a device to be used by multiple hosts with WUSB, a concurrent device must be utilized or the host must be changed over on the device side. Further, in a case where a concurrent device operates as a device connectable to multiple hosts, the processing load on the concurrent device increases if the number of hosts connected to the concurrent device increases. Further, with WUSB, the time during which a host communicates with a device is managed by an MMC (Micro-scheduled Management Command). If the number of hosts connected to a concurrent device increases, therefore, MMCs the number of which is equivalent to the number of hosts occupy communication time and this makes it difficult to assure time used for other communication.

With USB in an environment having a personal computer and a peripheral such as a printer, the computer and the peripheral execute processing such as print processing with the peripheral serving as the device and the personal computer serving as the host. In order for one device to be shared by multiple personal computers in a case where WUSB is utilized, therefore, it is necessary to change over the host using the peripheral device or to use a concurrent device as the peripheral. As a result, therefore, the load on the peripheral increases.

The present invention has been devised in view of these problems and provides a technique whereby a device can be shared efficiently by multiple hosts in a network having a host as a control apparatus and a device has a controlled apparatus.

### SUMMARY OF THE INVENTION

In order to solve the aforementioned problems, a communication system that includes a wireless apparatus having a host function in which the wireless apparatus serves as a control apparatus and a device function in which the wireless apparatus serves as a controlled apparatus constructs a first network, and wherein a first wireless apparatus serves as a host and a second wireless apparatus serves as a device, and constructs a second network in which the first wireless apparatus serves as a device and the second wireless apparatus serves as a host based upon a connection request transmitted from the second wireless apparatus to the first wireless apparatus via the first network.

In accordance with the present invention, a device such as a peripheral can be shared by multiple hosts efficiently without carrying out a complicated operation such as changeover performed by a user.

Further features of the present invention will become apparent from the following description of exemplary embodiments with reference to the attached drawings.

### BRIEF DESCRIPTION OF THE DRAWINGS

FIG. 1 is a diagram illustrating a system configuration;

FIG. 2 is a diagram illustrating the configurations of a printer and computer;

FIG. 3 is a diagram illustrating the structure of superframe in a WiMedia protocol and the structure of an MMC transaction group in WUSB;

FIG. 4 is a diagram illustrating connections of a second network;

FIG. 5 is a diagram illustrating the operating sequence of first and second networks;

FIG. 6 is a diagram illustrating the processing flow of a printer;

FIG. 7 is a diagram illustrating the flow of operation of a personal computer A and a personal computer B;

FIG. 8 is a diagram illustrating the flow of operation of a printer;

FIG. 9 is a diagram illustrating the operating sequence of first and second networks;

FIG. 10A and FIG. 10B are diagrams illustrating the processing flow of a printer;

FIG. 11A and FIG. 11B are diagrams illustrating the processing flow of a printer; and

FIG. 12 is a diagram illustrating the operating sequence of first and second networks in a fifth embodiment.

### DESCRIPTION OF THE EMBODIMENTS

### First Embodiment

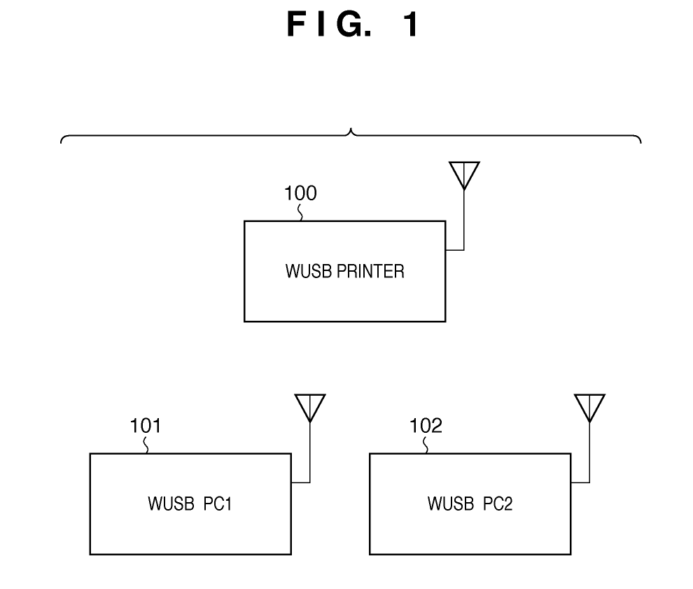

FIG. 1 is a diagram illustrating an example of the configuration of a wireless communication system in a first embodiment of the present invention. In this example of a wireless communication system, a WUSB system is used as the wireless communication system. As illustrated in FIG. 1, the system includes a printer 100 serving as a single first wireless apparatus and personal computers (PC 101 and PC 102), which are second wireless apparatuses that are external wireless apparatusus as seen from the first wireless apparatus.

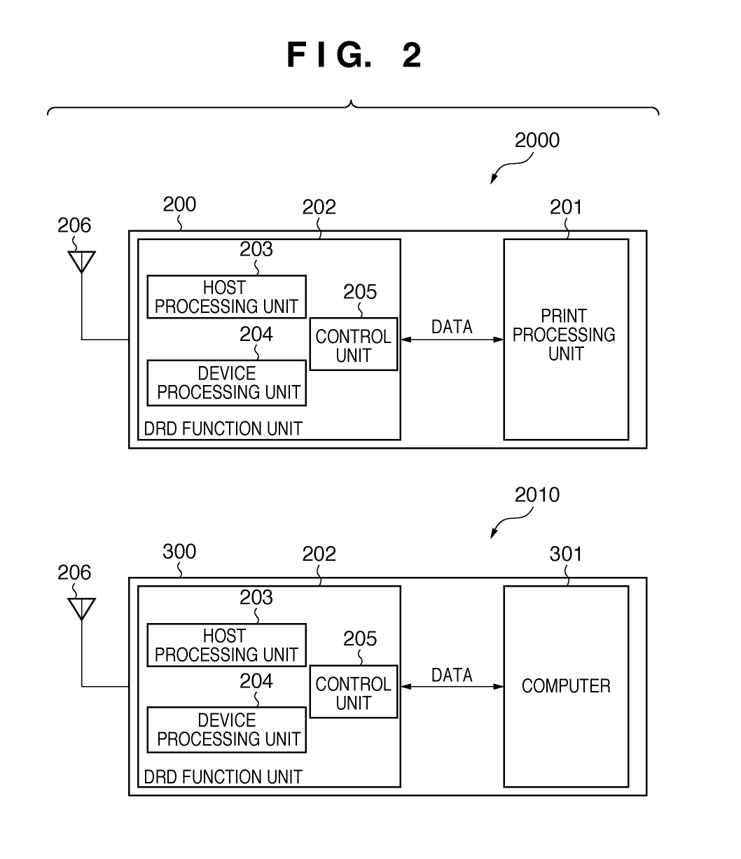

First, the configuration of a DRD having the functions of both a host and a device in the WUSB standard will be described. Indication 2000 of FIG. 2 illustrates the internal configuration of a printer equipped with a DRD function. Indication 2000 illustrates only the function blocks necessary for the description; other functions possessed by the overall DRD will not be described. A printer 200 having a DRD includes a print processing unit 201 and a DRD function unit 202. The DRD function unit 202 includes a host processing unit 203, a device processing unit 204 and a control unit 205 for controlling these. The control unit 205 has a memory in which a control program has been stored, and a CPU for executing this control program. The control unit 205 transmits a high-frequency signal to the host processing unit 203 in a case where a high-frequency signal received from an antenna 206 relates to a host, and transmits a high-frequency signal to the device processing unit 204 in a case where the received high-frequency signal relates to a device. The host processing unit 203 and device processing unit 204 perform data communication with the print processing unit 201 in accordance with the control signal from the control unit 205. The host processing unit 203 executes host processing and processing as a WiMedia device in WUSB.

The control unit 205 receives a connection request command from another DRD device. If the print processing unit is not currently being used, the device processing unit 204 is controlled to scan for another DRD host and to execute connection processing. The print processing unit 201, which belongs to the USB printer class, prints the print data received from the control unit 205. As illustrated in Indication 2000 of FIG. 2, the host processing unit 203 and device processing unit 204 are constructed independently for each function. However, the circuits of the host processing unit 203 and device processing unit 204 need not be independent circuits and may be consolidated within one integrated circuit. In a case where the host processing unit 203 and device processing unit 204 have been consolidated within one circuit, the control unit 205 controls the processing of each on a time-shared basis. Further, it is assumed here that the frequency band used by the host processing unit 203 and device processing unit 204 is the same hopping pattern within the frequency band used by WUSB.

Indication 2010 of FIG. 2 illustrates the internal construction of a personal computer 300 having a DRD function. The DRD computer 300 also includes the DRD function unit 202 having the host processing unit 203, device processing unit 204 and control unit 205. These units, as well as the antenna 206, have already been described in conjunction with Indication 2000 of FIG. 2 and need not be described again. The arrangement of the indication 2000 of FIG. 2 differs from that of the indication 2010 of FIG. 2 in that a computer 301 executes arithmetic processing and performs data communication with the control unit 205.

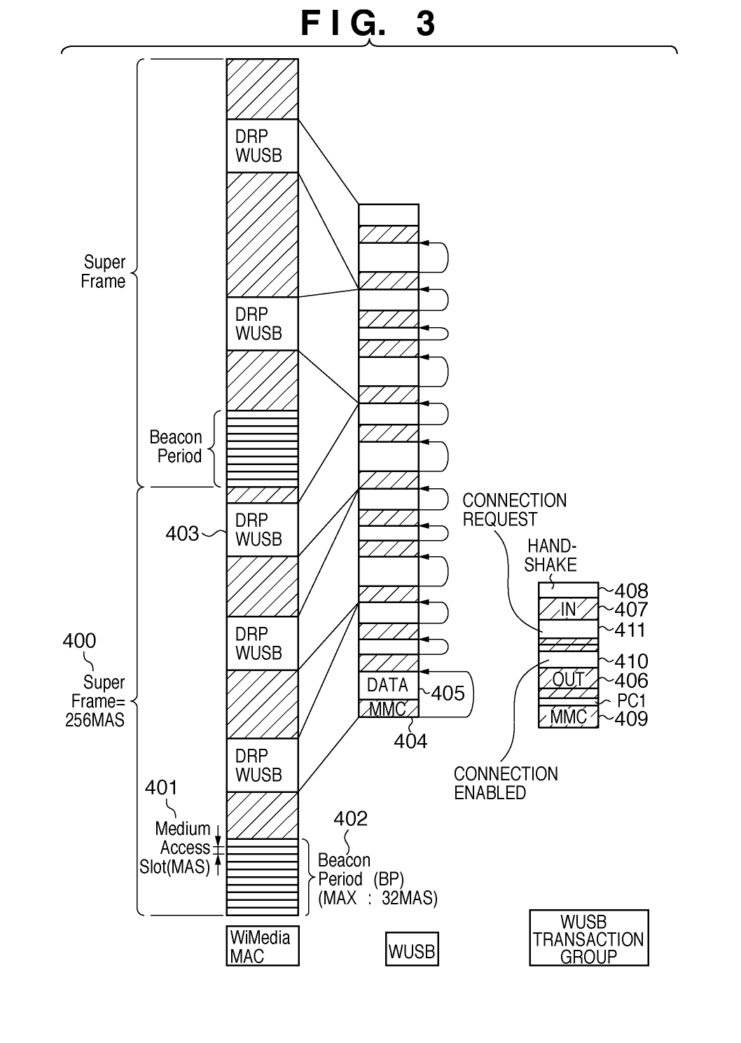

WiMedia communication and WUSB communication will be described next. FIG. 3 illustrates the structure of a superframe 400 of a MAC defined in WiMedia (the MAC will be referred to as a “WiMedia MAC” below) and the structure of a WUSB packet. The superframe 400 of the WiMedia MAC is transmitted repeatedly at a period of 65.536 ms. One superframe 400 consists of 265 medium access slots (referred to as “MAS” below). One MAS slot has a duration of 256 μS. The beginning of the superframe 400 is provided with a beacon period 402, which includes various control information, for beacon communication. Other data communication is performed using medium access slots 401 other than the beacon period 402 within the superframe 400. WUSB utilizes the physical layer and MAC layer of the WiMedia protocol and performs data communication using the DRP (Distributed Reservation Protocol). The DRP refers to a system in which by giving notification in advance using the beacon, a medium access slots 401 for communicating with another device are reserved and communication with the other device is carried out in the time period (403) of the medium access slots reserved by this DRP.

By using an MMC 404, the WUSB host manages the WUSB device within a range in which wireless communication is possible. The MMC 404 includes host identification information, device identification information and a designation of transmission time of the next MMC 404. Continuous data communication is performed by designating the time of the next MMC 404. A WUSB device receives the MMC 404 without participating in the physical layer and MAC layer of the WiMedia protocol and, if just a necessary data packet 405 is received, it is possible to transmit the data to the host.

With WUSB, first a data phase (data OUT 406) directed from the host to the device and a data phase (data IN 407) directed from the device to the host are scheduled in the data that follows the MMC 404. Scheduled next is a slot for handshake 408 from the device. The MMC 404, data OUT 406, data IN 407 and handshake 408 are referred to as a “transaction group”.

There are two methods of notifying a device as to whether connection to a host is possible or not, namely a method of notifying all devices that will be connected to the host and a method of notifying a specific device.

The method of notifying all devices that will be connected to a host does this by utilizing a reserved area and channel information element within the header of the MMC 404 of the host. The method of notifying a specific device designates, in the header of the MMC 404 of the host, an address 409 of a device to be notified of whether connection is possible or not, and thus notifies this device.

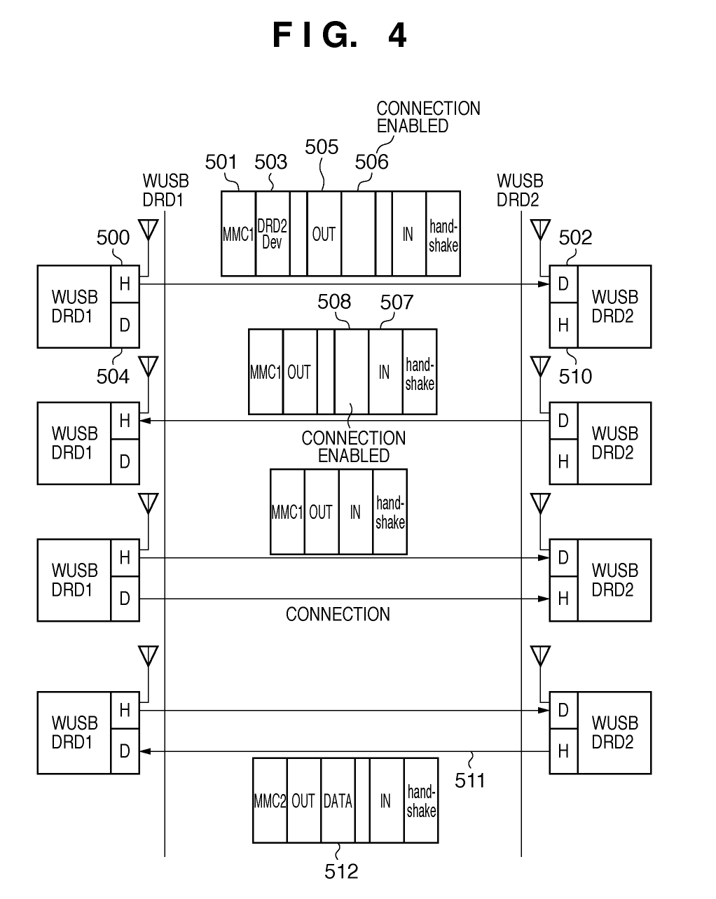

FIG. 4 illustrates notification of a specific device that connection is possible at the time of construction of the network, the connection operation and the sequence thereof. A DRD1 host 500 connects to a DRD2 device 502 and constructs a first network. The DRD1 host 500 designates an address (503) of the DRD2 device 502 with which it communicates using an MMC(1) 501. In a case where a DRD1 device 504 is connectable, the DRD1 host 500 transmits a connection-enabled notification 506, which notifies that connection is possible, to the DRD2 device 502 from data OUT 505. The DRD2 device 502 transmits a second-network connection request 508 to the DRD1 host 500 in the time slot of data IN 507. The DRD1 host 500 receives the connection request 508 from the side of the DRD2 device 502. While the first network is maintained, the DRD1 host 500 implements a connection from the DRD1 device 504 to a DRD2 host 510 and constructs a second network 511. The DRD2 host 510 transmits data 512 to the DRD1 device 504 via the second network 511 thus constructed.

If the DRD1 device 504 is not connectable, the DRD1 host 500 transmits a connection-disabled notification in data OUT 505. A method of notifying a specific device that connection is possible has been described in FIG. 4. In a case where all devices that will be connected to the host are notified, the connection enabled/disabled notification is performed using MMC 501. Doing so notifies all devices.

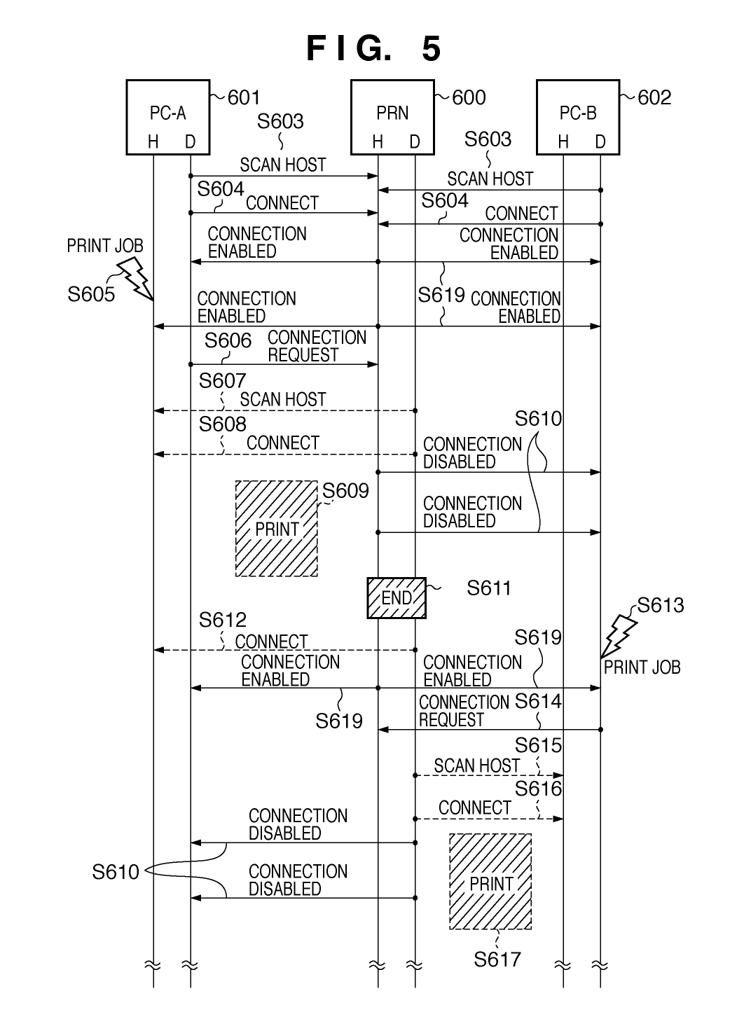

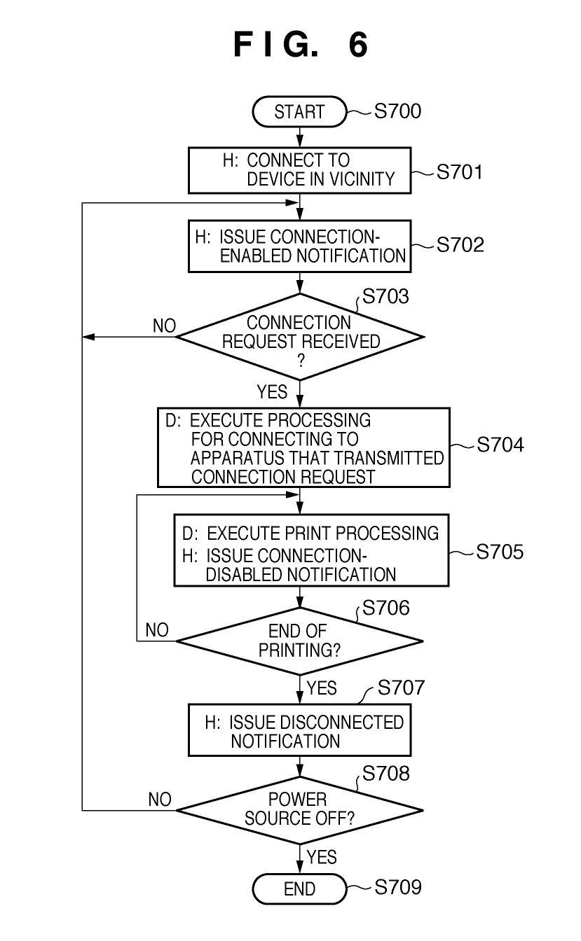

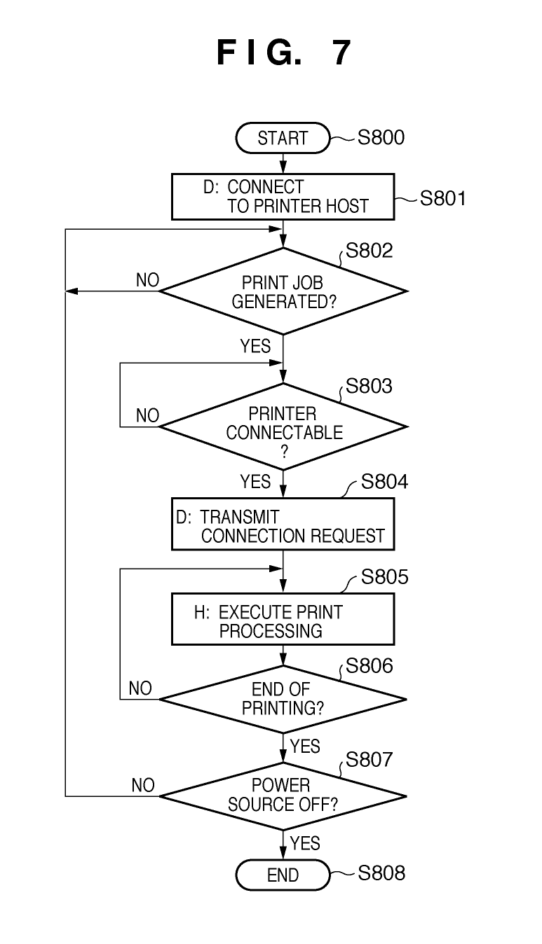

FIG. 5 illustrates the sequence of operation of a printer 600 (PRN) having a DRD function and two personal computers PC-A 601 and PC-B 602. FIG. 6 illustrates the flow of operation relating to the printer 600, and FIG. 7 illustrates the flow of operation relating to the personal computers PC-A601 and PC-B 602.

The solid-line arrows in the flow of operation shown in FIG. 5 represent communication in a first network configuration in which the printer is the host and the personal computers are the devices. The printer operates as the host via the host processing unit 203 by using the control unit 205 within the printer. The personal computers operate as devices via the device processing units 204 by using the control units 205 within the personal computers. The dotted-line arrows represent communication in a second network configuration in which the personal computers are the hosts and the printer is the device. In this case, the printer operates as a printer via the device processing unit 204 by using the control unit 205 within the printer. The personal computers operate as hosts via the host processing units 203 by using the control units 205. In the operating sequence or operating flow, the symbol “H” indicates host and the symbol “D” indicates device. It is assumed that association has already been completed in the communication between the printer and the personal computers that use the printer.

At S5603 in FIG. 5, the personal computer PC-A 601 and the personal computer PC-B 602 that use the printer 600 act as devices and scan for the host of the printer at start-up or at generation of a print job. If the personal computer PC-A 601 and personal computer PC-B 602 are capable of recognizing the printer 600, then the personal computers, which act as devices, execute processing for connecting to the host of the printer and construct the first network at S604. At S619, when the printer 600 is connectable, it notifies the personal computers, at regular intervals via the first network, of the fact that connection is possible.

A print job is generated in the personal computer PC-A 601 at S605. The personal computer PC-A 601 checks to determine whether the printer is connectable. Since notification of connectability has been given, as illustrated in FIG. 5, the personal computer PC-A 601 determines that the printer is connectable. Since the printer 600 is connectable, the personal computer PC-A 601 transmits a second-network connection request to the printer 600 through the first network at S606.

The printer 600 that has received the second-network connection request acts as the device and scans for the host of the personal computer PC-A 601 via the second network at S607. When the printer 600 is capable of recognizing the personal computer PC-A 601, the printer executes processing for connecting to the host of the personal computer PC-A 601 via the second network and constructs the second network at S608. The personal computer PC-A 601 executes print processing via the second network at S609.

At S610, during the time that the printer 600 is communicating with the personal computer PC-A 601 via the second network, i.e., during the time that the printer 600 is printing, the printer 600 gives notification, at regular intervals via the first network, that connection is not possible. This print-disabled notification is given using the first network and is received by the personal computers PC-A 601 and PC-B 602. As indicated also at S705 and S706 in FIG. 6, the communication means of the printer 600 continues outputting the print-disabled notification until communication with the personal computer PC-A 601 ends or until printing ends. The printer 600 terminates communication with the personal computer PC-A 601 or terminates printing at S611.

The printer 600 disconnects the personal computer PC-A 601 and the second network at S612. After disconnection of the second network, the printer 600 notifies the personal computers, at S619, that connection is possible.

A print job is generated in the personal computer PC-B 602 at S613. When the printer 600 is connectable, the personal computer PC-B 602 transmits a second-network connection request to the printer 600 through the first network at S614.

The printer 600 that has received the second-network connection request acts as the device and scans for the host of the personal computer PC-B 602 via the second network at S615. When the printer 600 is capable of recognizing the personal computer PC-B 602, the printer executes processing for connecting to the personal computer PC-B 602 and forms the second network in which the printer 600 is the device and the personal computer PC-B 602 is the host at S616. The printer 600 receives print data from the communication means of the personal computer PC-B 602 via the second network formed and executes print processing at S617. The printer issues a connection-disabled notification at S610 until printing ends.

This embodiment has been described for a case where there are two personal computers. However, in a case where there are three of more personal computers, the personal computers other than the personal computer currently involved in printing are notified of the fact that connection is not possible at S610.

FIG. 6 illustrates what portion of the flow of operation thus far involves mainly the printer 600. The printer 600 starts operating at step S700 when its power source is turned on. At step S701, the printer 600, which acts as the host, connects to each of the personal computers PC-A 601 and PC-B 602, which are the devices in the vicinity, and forms the first network.

At step S702, when the printer 600 is connectable, it notifies each personal computer, at regular intervals via the first network, of the fact that connection is possible. At step S703, the printer checks to determine whether a connection request based upon a print job has been received. Control proceeds to step S704 if such a request has been received or returns to step S702 if it has not been received.

At step S704, the printer 600, which acts as the device, scans for the host of the apparatus (the personal computer PC-A 601) that transmitted the connection request and does this via the second network. If the host of the personal computer PC-A 601 could be recognized, then the printer 600, which acts as the device, executes processing for connecting to the host of the personal computer PC-A 601 and constructs the second network. At step S705, the printer 600 prints the data received via the second network. Further, the printer 600 issues the connection-disabled notification using the first network. It should be noted that this notification is issued to all or some of the devices belonging to the first network.

At step S706, the printer 600 checks to determine whether printing has ended. Control returns to step S705 if printing has ended. When printing ends, the printer 600 disconnects the second network with the personal computer PC-A601 at step s707. If the printer 600 is turned off at step S708, the printer stops operating. If the printer 600 is not turned off, control returns to step S702.

The foregoing is the flow of operation relating to the printer 600.

Next, reference will be had to FIG. 7 to describe what portion of the flow of operation shown in FIG. 5 involves the personal computers PC-A 601 and PC-B 602. In FIG. 7, the personal computers are indicated as PC.

The personal computer starts operating at step S800 when its power source is turned on. At step S801, the personal computer, which acts as the device, scans for a host in the vicinity, connects to the host (printer 600) detected and forms the first network. The personal computer recognizes that a print job has been generated at step S802.

At step S803, the personal computer checks to determine whether connection to the printer 600 is possible. This determination can be made by checking for the connection-enabled or connection-disabled notification being transmitted by the printer 600. If connection to the printer is possible, then the personal computer transmits a second-network connection request to the printer 600 via the first network at step S804. If the personal computer is not connectable to the printer 600, then the personal computer performs the check repeatedly and waits for connection to become possible.

The personal computer transmits print data to the printer 600 via the second network and executes print processing at step S805.

At step S806, the personal computer checks to determine whether printing has ended. When printing ends, the personal computer checks to determine whether its power source is off at step S807. If the power source is off, the personal computer stops operating. If the power source is not off, control returns to step S802.

If the personal computer PC-A 601 or PC-B 602 that requested the connection of the second network could not be connected to the printer 600, then the printer 600 adjusts the wireless output (raises the transmission output) and re-connects at S608 or S616 in FIG. 5. Alternatively, the printer 600 notifies of the fact that it could not be connected to the personal computer via the first network or that the personal computer was outside the zone of recognition. Alternatively, the printer 600 issues a notification prompting that the personal computer be moved to another location. It should be noted that these notifications may be issued from the personal computer to the printer. Further, both re-connection and notification may be performed. By using this embodiment, it is possible for the printer to be shared by multiple personal computers in an efficient manner within the WUSB specifications.

### Second Embodiment

In the first embodiment, a network is disconnected whenever printing ends. In a second embodiment, the arrangement is such that if printing is performed successively using the same personal computer, it is possible for printing to be performed by maintaining the network without disconnect and re-connect processing being executed. The system configuration, WiMedia specifications, WUSB specifications, the connection-enabled/disabled notification and the second-network connection request in the second embodiment are similar to those of the first embodiment and need not be described again.

The sequence of operation of the printer 600, personal computer PC-A 601 and personal computer PC-B 602 in the second embodiment is similar to that of FIG. 5 except for the network disconnect sequence, which is different. It is assumed that association has already been completed in the communication between the printer 600 and the personal computers PC-A, PC-B that use the printer.

After printing using the personal computer PC-A 601 ends at S611 in the first embodiment, the printer 600 disconnects the personal computer PC-A 601 and the second network at S612. In the second embodiment, however, the characterizing feature is that after printing using the personal computer PC-A ends, the printer maintains the second network, without immediately disconnecting the personal computer PC-A and the second network, until a connection request is received from the other personal computer.

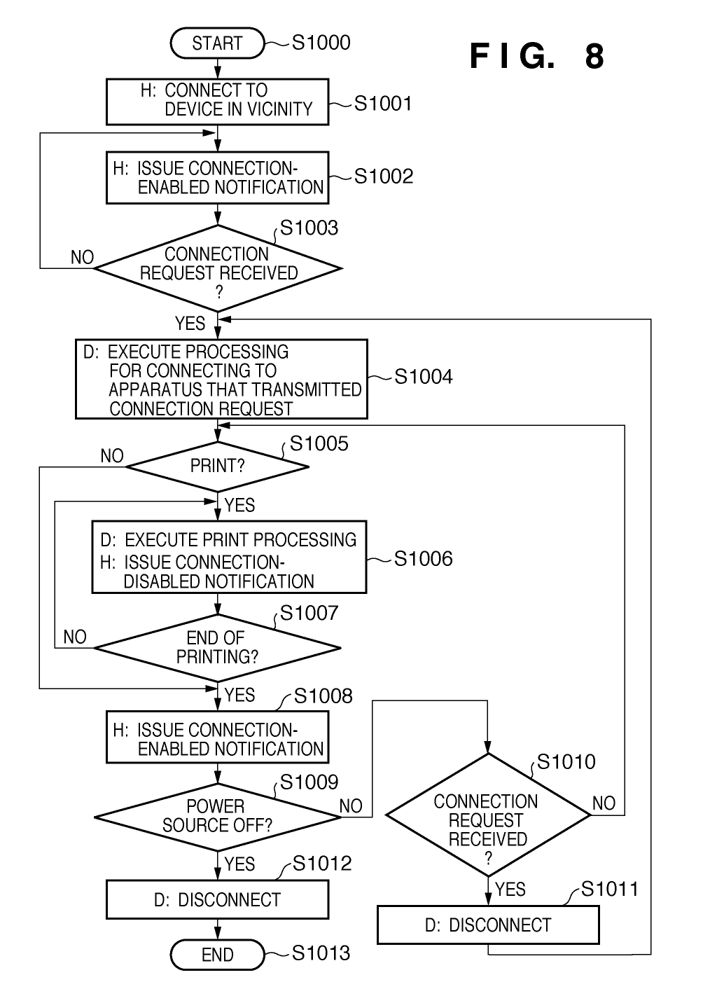

FIG. 8 illustrates the flow of operation of the printer in the second embodiment. The printer 600 starts operating at step S1000. At step S1001, the printer 600, which acts as the host, connects to the personal computer, which is the device in the vicinity, and forms the first network.

At step S1002, when the printer 600 is connectable to the personal computer, it notifies the personal computer in the vicinity, at regular intervals via the first network, of the fact that connection is possible. At step S1003, the printer checks to determine whether a connection request based upon a print job has been received. Control proceeds to step S1004 if such a request has been received or returns to step S1002 if it has not been received.

At step S1004, the printer 600, which acts as the device, scans for the host of the apparatus (the personal computer PC-A 601) that transmitted the connection request and does this via the second network. If the host of the personal computer PC-A 601 could be recognized, then the printer 600, which acts as the device, executes processing for connecting to the host of the personal computer PC-A 601 and constructs the second network. At step S1005, the printer 600 checks to determine whether print data is received. Control proceeds to step S1006 if print data is received. Otherwise, control proceeds to step S1008.

At step S1006, the printer 600 executes print processing of the print data received from the personal computer PC-A 601 via the second network formed. The printer then gives notification of the fact that connection to personal computers in the vicinity is not possible. At step S1007, the printer 600 checks to determine whether printing has ended. Control returns to step S1006 if printing has ended. If printing has ended, control proceeds to step S1008.

At step S1008, the printer 600 notifies all or some of the devices belonging to the first network of the fact that it itself is connectable and does this via the first network. The printer 600 checks to determine whether its power source is off at step S1009. If the power source is still on, then, at step S1005 or S1010, the printer 600 continues to determine whether a connection request from another personal computer (PC-B 602) or print data from the personal computer PC-A 601 is received. The printer 600 continues to transmit the connection-enabled notification at step S1008 in circulating fashion.

Assume that a print job is generated in the personal computer PC-B 602 when the printer 600 is connectable. The personal computer PC-B 602 determines that the printer is connectable and transmits the second-network connection request to the printer 600 via the first network.

When the printer 600 receives the second-network connection request at step S1010, it disconnects the second network, which is presently connected to the personal computer PC-A 601, at step S1011 and returns control to step S1004. At step S1004, the printer 600, which acts as the device, scans for the host of the personal computer PC-B 602 by the second network and executes processing for connecting to the second network if the personal computer PC-B 602 could be recognized. Accordingly, the second network, in which the printer 600 is the device and the personal computer PC-B is the host, is formed.

At step S1005, the printer 600 receives print data from the personal computer PC-B 602 via the second network formed and executes print processing. At step S1006, the printer 600 notifies all or some of the devices belonging to the first network of the fact that it itself is not connectable and does this via the first network. The printer 600 checks to determine whether its power source is off at step S1009. At steps S1007 and S1008, after the end of printing, the printer notifies all or some of the devices belonging to the first network of the fact that it itself is connectable, without disconnecting the personal computer PC-B 602 and second network, and does this via the first network.

Processing in a case where connection of the second network could not be achieved is similar to that of the first embodiment and need not be described again.

By using this embodiment, it is possible for the printer to be shared by multiple personal computers in an efficient manner within the WUSB specifications. Furthermore, in a case where printing is performed successively by the same personal computer, it is possible to perform printing without executing disconnect and re-connect processing.

### Third Embodiment

In a third embodiment, it is so arranged that when one or more connection requests are issued from other personal computers while a printer is currently executing print processing, the connection requests are registered in order. A further characterizing feature of this embodiment is that after print processing ends, the printer constructs a network with the personal computer that issued the connection request and does this in the order in which the connection request was registered. The system configuration, WiMedia specifications and WUSB specifications in the third embodiment are similar to those of the first embodiment and need not be described again. The connection-enabled/disabled sequences are as set forth in the operation sequences described thus far. The connection-enabled/disabled notification is transmitted in the time slot of data OUT or MMC header of the host, and the connection request is transmitted in the time slot of data In of the host. Further, the connection of the second network configuration is performed without disconnecting the first network in this embodiment as well.

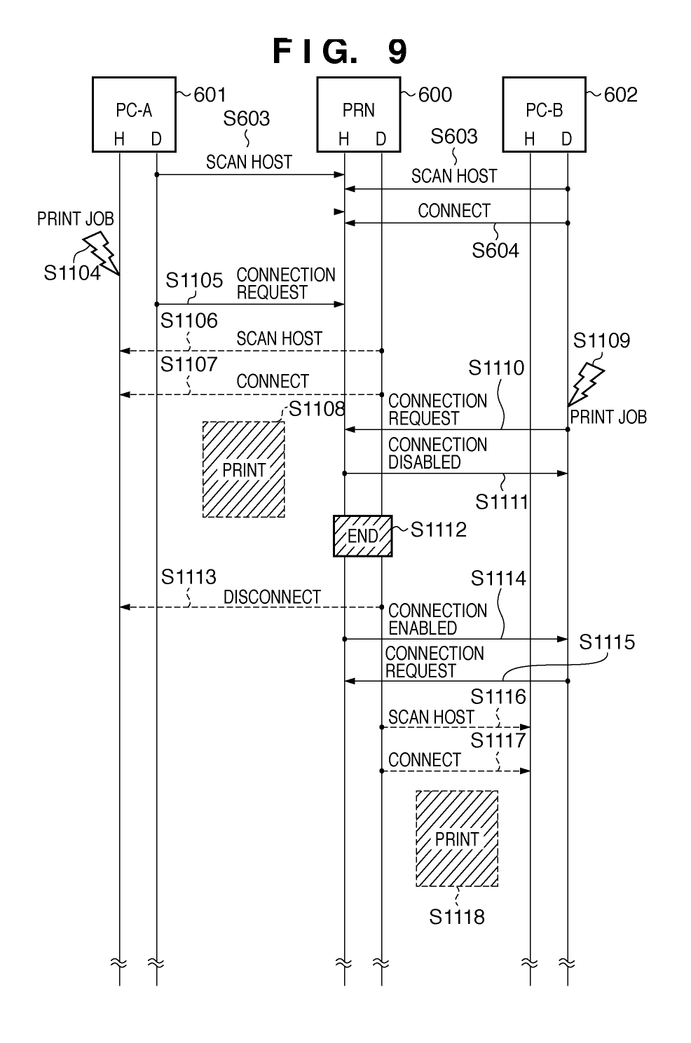

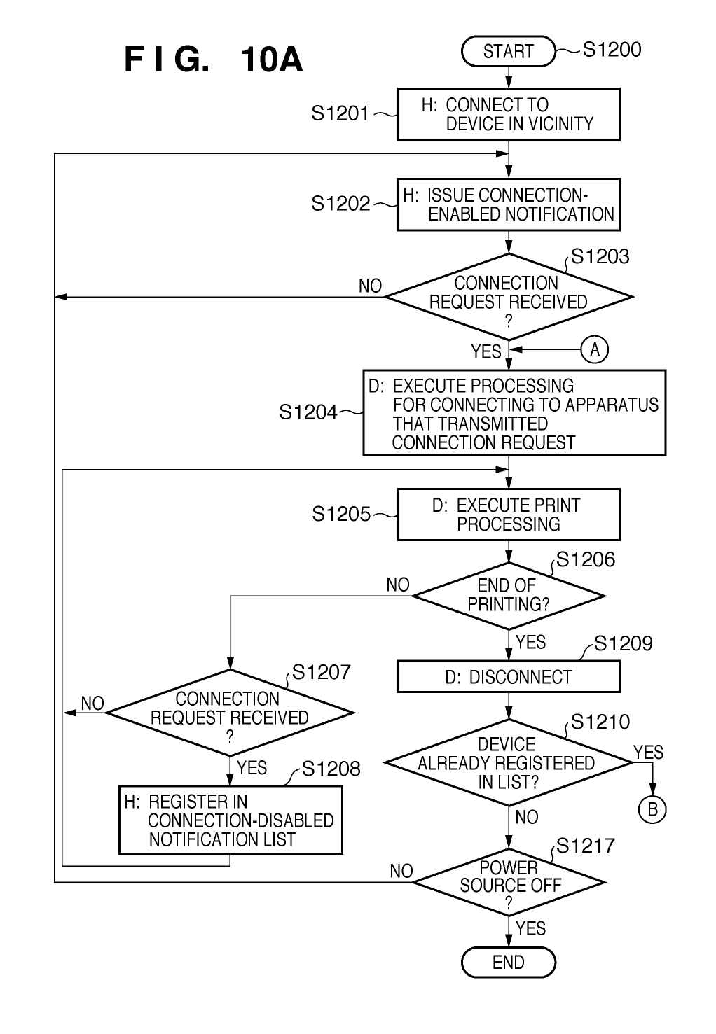

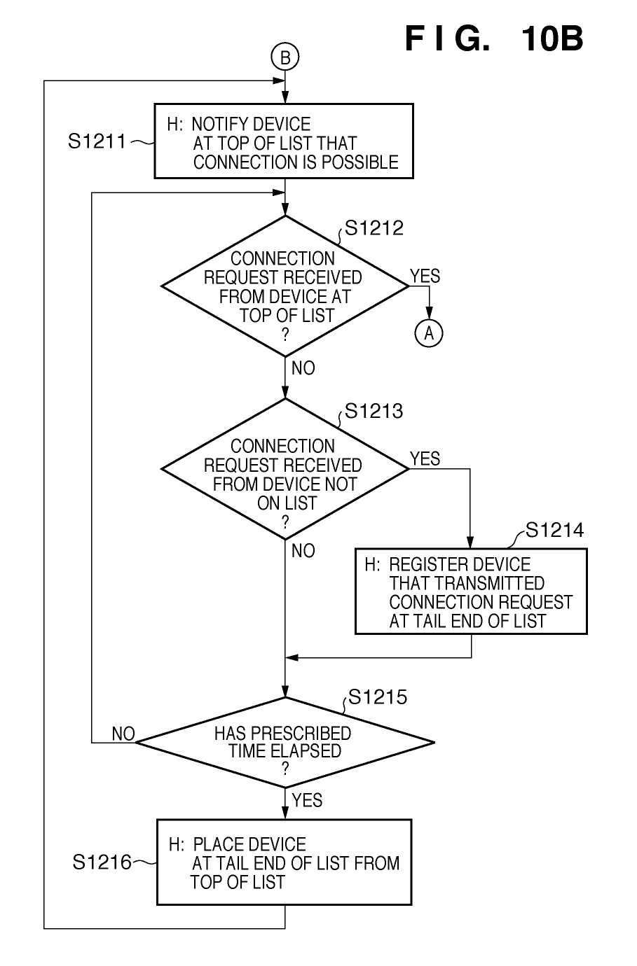

FIG. 9 illustrates an example of the sequence of operation of the printer 600, personal computer PC-A 601 and personal computer PC-B 602 in the third embodiment. FIG. 10A and FIG. 10B illustrate an example of the flow of operation of the printer 600. It is assumed that association has already been completed in the communication between the printer 600 and the personal computers PC-A 601, PC-B 602 that use the printer 500.

The sequence of operation of the connection of the devices of personal computers PC-A 601, PC-B 602 to the host of printer 600 is the same as the operation sequence at S603 and S604 in FIG. 5 of the first embodiment and need not be described again.

A print job is generated in the personal computer PC-A 601 at S1104. The personal computer PC-A 601 transmits a second-network connection request to the printer 600 through the first network at S1105. If the second network is connectable, the printer 600 that has received the second-network connection request scans for the host of the personal computer PC-A 601 via the second network at S1106.

When the printer 600 is capable of recognizing the personal computer PC-A 601, the printer acts at S1107 as the device and forms the second network in which the personal computer PC-A 601 is the host. The printer 600 executes print processing at S1108. At S1109, during the time that the printer 600 is communicating with the personal computer PC-A 601 via the second network, i.e., during the time that the printer 600 is printing, a print job is generated in the personal computer PC-B 602. The personal computer PC-B 602 transmits the second-network connection request to the printer 600 via the first network at S1110.

Since the printer 600 that received the second-network connection request is currently printing, at S1111 the printer notifies the personal computer PC-B 602 via the first network of the fact that the second network is not connectable. The printer 600 registers the personal computer PC-B 602 in a list as the device that transmitted the second-network connection request. The personal computer PC-B 602 waits until it receives the second-network connection-enabled notification transmitted by the printer 600 after printing ends.

The printer 600 finishes print processing at S1112. Since the printer 600 has not received a print job from the same personal computer, it disconnects the personal computer PC-A 601 and the second network at S1113. Since the fact that a connection request has been issued from the personal computer PC-B 602 has been registered in the list of the printer 600, at step S1114 the printer 600 notifies the personal computer PC-B 602 that connection of the second network is possible. Upon receiving this notification, the personal computer PC-B 602 again transmits the second-network connection request to the printer 600 via the first network at S1115.

The printer 600 acts as the device and scans for the host of the personal computer PC-B 602 via the second network at S1116.

When the printer 600 is capable of recognizing the personal computer PC-B 602, the printer acts as the device and forms the second network in which the personal computer PC-B 602 is the host at S1117. The printer 600 receives print data from the personal computer PC-B 602 via the second network formed and executes print processing at S1118.

The sequence of operation shown in FIG. 9 will be described using the flowchart of FIG. 10A and FIG. 10B. The printer 600 starts operating at step S1200. At step S1201, the printer 600, which acts as the host, connects to the personal computers PC-A601, PC-B602, which are the devices in the vicinity, and forms the first network. At step S1202, when the printer 600 is connectable, it notifies each personal computer, at regular intervals via the first network, of the fact that connection is possible. At step S1203, the printer 600 checks to determine whether a connection request based upon a print job has been received. Control proceeds to step S1204 if such a request has been received or returns to step S1202 if it has not been received.

At step S1204, the printer 600, which acts as the device, scans for the host of the apparatus (the personal computer PC-A 601) that transmitted the connection request and does this via the second network. If the host of the personal computer PC-A 601 could be recognized, then the printer 600, which acts as the device, executes processing for connecting to the host of the personal computer PC-A 601 and constructs the second network. At step S1205, the printer 600 executes print processing of the print data received via the second network. At step S1206, the printer 600 checks to determine whether printing has ended. Control proceeds to step S1209 if printing has ended. If printing has not ended, control proceeds to step S1207.

At step S1207, the printer 600 checks to determine whether a connection request has been received from the other personal computer. Control proceeds to step S1208 if a connection request has been received or returns to step S1205 if a connection request has not been received.

At step S1208, the printer 600 transmits the connection-disabled notification to the device (personal computer PC-B 602) that transmitted the connection request. Further, the printer 600 registers the device that transmitted the connection request in the list. If there are already registered devices in the list, then registration in the list is performed by registering this device at the tail end of the list.

If it is found at step S1206 that printing has ended, then the printer 600 disconnects the personal computer PC-A 601 and the second network at step S109. At step S1210, the printer 600 checks to determine whether a device has been registered in the list. If a device has been registered, control proceeds to step S1211. Otherwise, control proceeds to step to step S1217. If the power source is turned off, operation ceases. If the power source has not been turned off, control returns to step S1202. In this example, control proceeds from step S1210 to step S1211 because the personal computer PC-B 602 has been registered at the beginning of the list of printer 600. At step S1211, the printer 600 notifies the personal computer PC-B 602 via the first network of the fact that the second network is connectable.

In this example, the personal computer PC-B 602 receives the notification that the second network is connectable and transmits a connection request to the printer 600 via the first network. If the printer 600 receives the connection request from the device (personal computer PC-B 602) at the top of the list (“YES” at step S1212), which is the device that issued the connection-enabled notification, then control returns to step S1204, the printer 600 forms the second network with the personal computer PC-B 602 and executes print processing with this device. If the printer 600 does not receive the connection request (“NO” at step S1212) from this device even though the connection-enabled notification has been issued, then control proceeds to step S1213.

At step S1213, the printer 600 checks to determine whether a connection request has been issued from a device not registered in the list. If such a connection request has been issued, control proceeds to step S1214, the device that issued the connection request is registered at the tail end of the registration list and control proceeds to step S1215. If such a connection request has not been issued, then control proceeds to from step S1212 to step S1215.

At step S1215, the printer 600 waits a prescribed period of time for the connection request of step S1213. If the prescribed period of time elapses at step S1215, then the printer 600 re-registers the device at the top of the list from the top to the tail end of the list and control returns to step S1211.

The flow of operation of the personal computers in this embodiment is almost the same as that of the flow of operation shown in FIG. 7. What is different is that in a case where a connection request to the printer 600 is issued and a connection-disabled response is received, the transmission of the connection request is suspended and the personal computer waits for connection-enabled to be sent from the printer 600 via the first network. When connection-enabled is received from the printer 600, the personal computer transmits the connection request to the printer 600 and constructs the second network. This is the characterizing feature of this embodiment.

In the operation sequence of FIG. 9, a connection request is issued from the other personal computer when printing by the personal computer PC-A 601 is in progress. In the case of three or more personal computers, these are listed successively at step S1208 of FIG. 10A in a manner similar to that described above. “PLACE DEVICE AT TAIL END OF LIST” is indicated at step S1216. However, this embodiment is not limited to this arrangement; this device (personal computer) may just as well be deleted from the list. Processing in a case where connection of the printer could not be performed is similar to that of the first embodiment and need not be described again.

In accordance with this embodiment, a connection request can be received even if printing is in progress. When printing ends, priority can be given to execution of print processing with the device that transmitted the connection request during printing. Further, connection requests can be received from multiple devices during printing, and print processing can be executed upon connecting in the order in which the requests were received. Further, when a device that transmitted a connection request during printing is connected to after the end of printing, this device is notified of the fact that connection is allowed and the connection is made when a response from this device is received. In other words, since a connection is actually made after connecting is re-confirmed, it is possible to avoid a needless connection such as connecting to a device, which has refused a connection, despite the fact that another device has been connected to complete the printing operation.

### Fourth Embodiment

A fourth embodiment is a modification of the third embodiment. In the third embodiment, the second network is disconnected following the end of printing. By contrast, in the fourth embodiment, the printer disconnects the second network when printing ends in a case where the printer has received a connection request from the other personal computer during print processing.

In other words, in FIG. 9 of the third embodiment, the second network is disconnected at S113 when printing (communication) in the second network ends at S1112. The fourth embodiment is so arranged that even though printing in the second network is finished, the printer 600, without disconnecting the second network, notifies the devices belonging to the first network of the fact that the second network is connectable, this notification being given via the first network. Then, upon receiving a second-network connection request via the first network, the printer 600 disconnects the second network currently connected and constructs a second network with the host of the device that requested the connection.

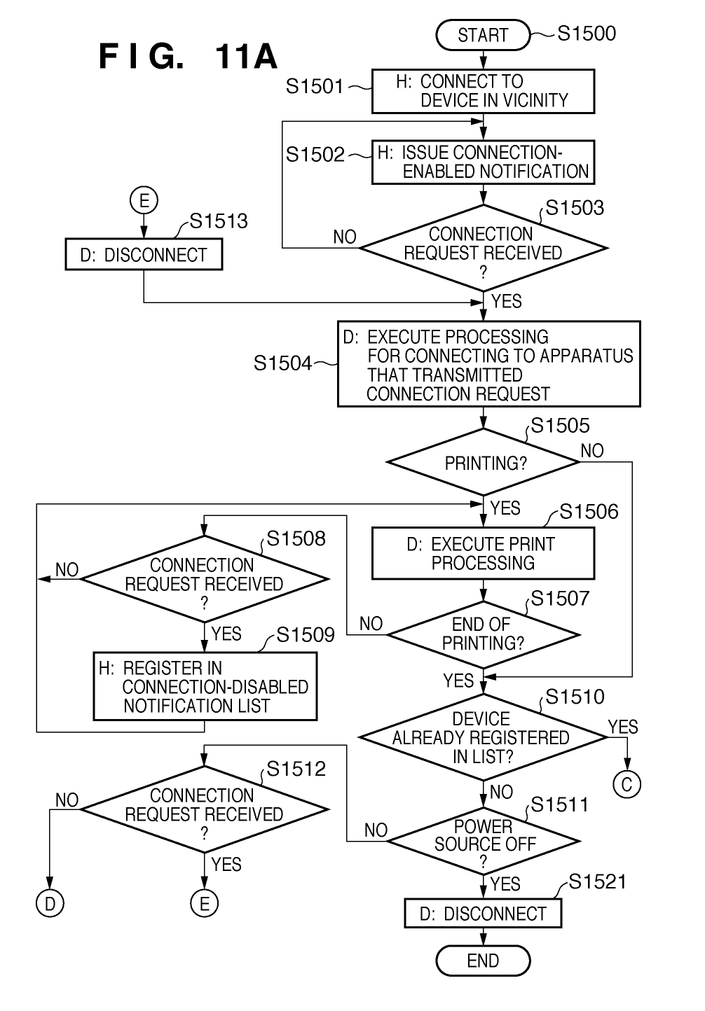

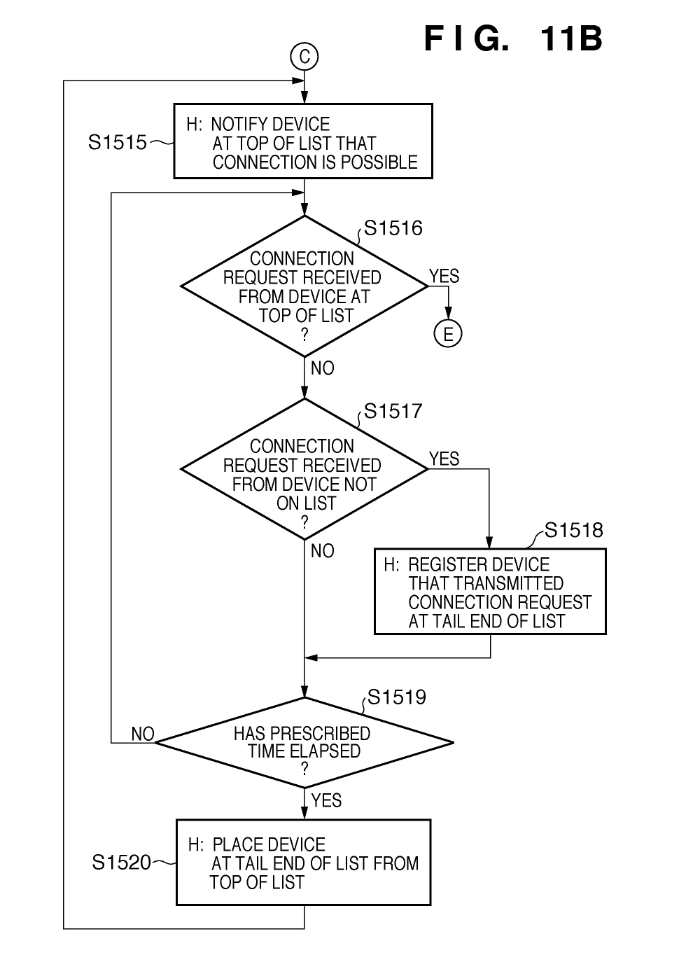

The flow of operation of the printer 600 according to this embodiment is illustrated in FIG. 11A and FIG. 11B. The printer 600 starts operating at step S1500. At step S1501, the printer 600, which acts as the host, connects to the personal computers PC-A601, PC-B602, which are the devices in the vicinity, and forms the first network. At step S1502, the printer 600 notifies each personal computer, at regular intervals via the first network, of the fact that connection is possible. At step S1503, the printer 600 checks to determine whether a connection request based upon a print job has been received. Control proceeds to step S1504 if such a request has been received or returns to step S1502 if it has not been received.

At step S1504, the printer 600, which acts as the device, scans for the host of the apparatus (the personal computer PC-A 601) that transmitted the connection request and does this via the second network. If the host of the personal computer PC-A 601 could be recognized, then the printer 600, which acts as the device, executes processing for connecting to the host of the personal computer PC-A 601 and constructs the second network. At step S1505, the printer 600 checks to determine whether print data is received. Control proceeds to step S1506 if print data has been received or to step S1510 if it has not been received. At step S1506, the printer 600 executes print processing of the print data received from the personal computer PC-A 601 via the second network formed. At step S1507, the printer 600 checks to determine whether printing has ended. Control proceeds to step S1510 if printing has ended. If printing has not ended, control proceeds to step S1508.

At step S1508, the printer 600 checks to determine whether a connection request has been received from the other personal computer. Control proceeds to step S1509 if a connection request has been received or returns to step S1506 if it has not. At step S1509, the printer 600 transmits the connection-disabled notification to the device (personal computer PC-B 602) that transmitted the connection request. Further, the device that transmitted the connection request is registered in the list by the printer 600. If there are already registered devices in the list, then registration in the list is performed by registering this device at the tail end of the list. If it is found at step S1507 that printing has ended, then the printer 600 checks to determine whether a device has been registered in the list at step S1510. If a device has been registered, control proceeds to step S1505. Otherwise, control proceeds to step to step S1511. Monitoring is performed at step S1511 to determine whether the power source is turned off. If the power source is turned off, then the printer disconnects the currently connected first and second networks at step S1521 and terminates operation. If the power source has not been turned off, control returns to step S15122.

At step S1512, the printer 600 determines whether a connection request has been received from the other personal computer. Control returns to step S1505 if a connection request has not been received. If a connection request has been received, the printer disconnects the currently connected second network at step S1513. At step S1504, the printer connects to the device that transmitted the connection request and then executes the processing from step S1505 onward. If it is found at step S1510 that a device has been registered in the list, then, at step S1515, the printer notifies the device (personal computer PC-B 602) at the top of the list of the fact that the second network is connectable. This notification is given via the first network.

In this example, the personal computer PC-B 602 receives the notification that the second network is connectable and transmits a connection request to the printer 600 via the first network. If it is found at step S1516 that the printer 600 has received the connection request from the device (personal computer PC-B 602) at the top of the list, which is the device that issued the connection-enabled notification, then control proceeds to step S1513 and the printer disconnects the currently connected personal computer PC-A 601 and the second network. At step S1504, the printer forms the second network with the personal computer PC-B 602 and executes print processing with this device. If the printer 600 does not receive the connection request from this device even though the connection-enabled notification has been issued, control proceeds from step S1516 to step S1517.

At step S1517, the printer 600 checks to determine whether a connection request has been issued from a device not registered in the list. If such a connection request has been issued, control proceeds to step S1518, the device that issued the connection request is registered at the tail end of the registration list and control proceeds to step S1519. If such a connection request has not been issued, then control proceeds from step S1517 to step S1519. At step S1519, the printer 600 waits a prescribed period of time for the connection request of step S1213. If the prescribed period of time elapses, then the printer 600 re-registers the device at the top of the list from the top to the tail end of the list at step S1520 and control returns to step S1511.

Thus, an effect obtained in addition to the effects of the third embodiment is that in a case where the same personal computer prints successively, printing can be performed without disconnect and re-connect processing being executed.

### Fifth Embodiment

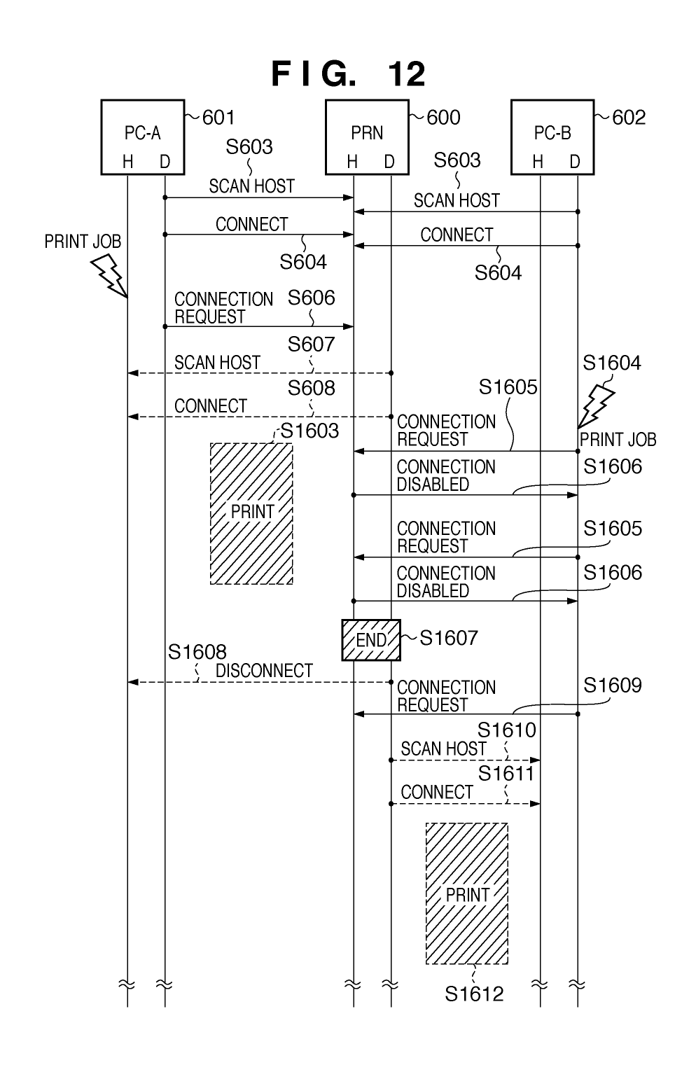

The sequence of operation of the printer 600, personal computer PC-A 601 and personal computer PC-B 602 according a fifth embodiment is illustrated in FIG. 12. This embodiment is so arranged that if there is a connection request from another personal computer during execution of printing (communication), the printer 600 transmits connection-disabled (S1606) and immediately disconnects the second network (S1608) after printing ends, just as in the first embodiment. However, the characterizing feature of this embodiment is that the connection request from the other personal computer is received and the second network is constructed with this other personal computer without connection-enabled being transmitted. Accordingly, this embodiment differs from the first embodiment in that the printer 600 notifies that connection is allowed at step S702 in FIG. 6. Further, even though the personal computer receives the connection-disabled notification from the printer 600, it transmits the connection request to the printer 600 at regular intervals (S1604). Upon receiving the connection request (S1609) after the second network is disconnected, the printer 600 connects to this personal computer and executes print processing (S1610 to S1612).

In accordance with the arrangement of this embodiment, therefore, it is possible for the printer to be shared by multiple personal computers.

### Sixth Embodiment

A sixth embodiment is a modification of the fifth embodiment. In the fifth embodiment, the second network in which the personal computer PC-A 601 serves as the host is disconnected immediately after the end of printing. In the sixth embodiment, however, the second network in which the personal computer PC-A 601 serves as the host is not disconnected immediately after the end of printing but is disconnected after a connection request from the personal computer PC-B 602 is received. As a result, in a case where the same personal computer performs printing successively, it is possible to perform printing without executing connect and re-connect processing.

Use of two personal computers has been described in each of the foregoing embodiments. However, operation is similar with three of more personal computers and this embodiment is not limited to personal computers. Further, in this embodiment, a printer has been described as a computer peripheral. However, it does not matter even if the computer peripheral is a card reader, storage device, scanner, speaker or projector, etc., and these peripherals can be shared by multiple personal computers by a similar arrangement.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-101380, filed Apr. 17, 2009, which is hereby incorporated by reference herein in its entirety.

What is claimed is:

1. A method of configuring a network of a communication system comprising a wireless apparatus having a host function in which the wireless apparatus serves as a control apparatus and a device function in which the wireless apparatus serves as a controlled apparatus, and wherein
a first wireless apparatus for configuring a first network wherein the first wireless apparatus serves as a host and a second wireless apparatus serves as a device, and for configuring a second network, wherein the first wireless apparatus serves as a device and the second wireless apparatus serves as a host, based upon a connection request transmitted from the second wireless apparatus to the first wireless apparatus via the first network.

2. The method according to claim 1, wherein the first wireless apparatus transmits a signal for indicating that the first wireless apparatus is not connectable via the first network while communication via the second network is in progress.

3. The method according to claim 1, wherein the second network is disconnected after data communication via the second network is terminated.

4. The method according to claim 1, wherein after data communication via the second network is terminated, the first wireless apparatus transmits a signal for indicating that the first wireless apparatus is connectable via the first network.

5. The method according to claim 1, wherein even if data communication via the second network is terminated, the second network is maintained until a connection request of the second network is transmitted via the first network.

6. The method according to claim 1, wherein if the first wireless apparatus receives a second-network connection request from a third wireless apparatus via the first network while the first wireless apparatus is communicating with the second wireless apparatus via the second network, the first wireless apparatus transmits a signal for indicating that connection is not possible, to the third wireless apparatus via the first network.

7. The method according to claim 1, wherein if the first wireless apparatus receives a connection request of the second network via the first network while the first wireless apparatus is communicating with the second wireless apparatus via the second network, the first wireless apparatus registers the apparatus that transmitted said connection request,
the first wireless apparatus disconnects the second wireless apparatus and the second network after communication with the second wireless apparatus via the second network is terminated and
the first wireless apparatus configures a second network, in which the registered apparatus serves as a host and the first wireless apparatus serves as a device, after the second network is disconnected.

8. A communication system including a wireless apparatus having a host function in which the wireless apparatus serves as a control apparatus and a device function in which the wireless apparatus serves as a controlled apparatus, wherein a first wireless apparatus and a second wireless apparatus comprising:
a first construction unit for configuring a first network wherein the first wireless apparatus serves as a host and the second wireless apparatus serves as a device; and
a second construction unit for configuring a second network, wherein the first wireless apparatus serves as a device and the second wireless apparatus serves as a host, based upon a connection request transmitted from the second wireless apparatus to the first wireless apparatus via the first network.

9. A wireless apparatus which is a first wireless apparatus having a host function in which the first wireless apparatus serves as a control apparatus and a device function in which the first wireless apparatus serves as a controlled apparatus, comprising:
a host unit for configuring a first network wherein the first wireless apparatus serves as a host and another wireless apparatus serves as a device; and
a device unit for configuring a second network wherein a second wireless apparatus that transmitted a connection request to the first wireless apparatus via the first network serves as a host and the first wireless apparatus services as a device.

10. A wireless apparatus which is a second wireless apparatus having a host function in which the second wireless apparatus serves as a control apparatus and a device function in which the second wireless apparatus serves as a controlled apparatus, comprising:
a device unit for configuring a first network wherein a first wireless apparatus serves as a host and the second wireless apparatus serves as a device; a request unit for requesting configuration of a second network, via the first network, wherein the first wireless apparatus serves as a device and the second wireless apparatus serves as a host; and
a host unit for configuring the second network.
